(19) United States
(12) Patent Application Publication
(10) Pub. No.: US 2008/0142688 A1
(43) Pub. Date: Jun. 19, 2008

(54) Reflection Type Optical Detector

(76) Inventor: Takashi Nagase, Fukuoka (JP)

Correspondence Address: SUGHRUE-265550, 2100 PENNSYLVANIA AVE. NW, WASHINGTON, DC, 20037-3213, US

(21) Appl. No.: 11/658,015

(22) PCT Filed: Jun. 8, 2005
(86) PCT No.: PCT/JP2005/010496

§ 371 Date: Jan. 22, 2007

(30) Foreign Application Priority Data
Jul. 22, 2004 (JP) 2004-213939

(51) Int. Cl. H01J 40/14

(52) U.S. Cl. 250/216

(57) ABSTRACT

It is an object of the invention to provide a reflection type optical detector including a detecting unit having a structure preventing outer shape dimensions of a light emitting portion and a light receiving portion from being increased, capable of being integrated by a small size and with a high accuracy and capable of being integrated simply.

A reflection type optical detector of the invention is constituted by a relatively moving main slit (1) and a detecting unit (2) opposed thereto, the detecting unit is constituted at least by a light emitting portion (5) and a light emitting portion slit (7) and a light receiving portion (6), the detecting unit includes a resin molded board (41) capable of carrying out three-dimensional wirings, a portion of the resin molded board is directly arranged with a light emitting element (51) of the light emitting portion, a periphery of the light emitting element is provided with a reflecting portion (57) in a shape of a fulcrum of circular cone, and the reflecting portion is formed by a metal wiring pattern for electrically connecting the light emitting element.

### TECHNICAL FIELD

The present invention relates to a reflection type optical detector, particularly relates to a structure of integrating a light emitting portion and a light receiving portion.

### BACKGROUND ART

In a background art, there is an optical linear encoder as a detector for detecting a position in a linear line direction.

Further, in an optical encoder, a so-to-speak reflection type optical detector using three lattices is known (refer to, for example, Patent Reference 1).

The reflection type optical detector using three lattices will be explained in reference to drawings. FIG. 11 is a side sectional view showing an encoder of a background art. In the drawing, numeral 1 designates a main scale, numeral 2 designates a detecting unit, numeral 3 designates a board, numeral 4 designates a sub-board, numeral 5 designates a light emitting portion, numeral 6 designates a light receiving portion, numeral 7 designates a light emitting portion slit, numeral 9 designates a bonding wire, numeral 10 designates an electronic part. FIG. 12 is a perspective view showing an outlook of the detecting unit 2 of FIG. 11.

The main scale 1 is formed with slits at a glass face on one side by using a vapor deposition technology. According to the detecting unit 2, the sub-board 4 and the electronic part 10 are arranged on the board 3, and the sub-board 4 is provided with the light emitting portion 5, the light receiving portion 6 and the light emitting portion slit 7.

The light emitting portion 5 is constituted by LED 51 and an LED case 52 and glass 53 as well as a spacer 54 for fixing LED in a predetermined dimension, LED 51 is connected to an LED terminal 55 by the bonding wire 9, and connected to the board 3 by a lead 56. Further, light emitted by LED 51 constitutes substantially a point light source, and irradiated to the main scale 1 by passing the light emitting portion slit 7 for the LED light source. Further, a reflecting portion 57 in a shape of a frustrum of circular cone is provided to an inner wall of the LED case 52 made of a metal to constitute a structure of irradiating a light emitted by LED 51 efficiently to outside, which is protected by the glass 53.

The light receiving portion 6 is arranged with 2 pieces of slit-like photodiodes 61, 62 having a structure of being arranged with a plurality of pieces of photodiodes constituting photoelectric conversion elements in a slit-like shape, and is constructed by a constitution in which light reflected by the main scale 1 is received by the respective photodiodes, converted into an electric signal, amplified and shaped in a waveform thereof by the electric part 9 of the board 3 by way of the bonding wire 9, the sub-board 4, thereafter, transmitted to outside of the detecting unit 2 as an electric signal.

Further, there is constituted a system of receiving light emitted by LED 51 by 2 sets of the slit-like photodiodes 61, 62 by passing routes indicated by dotted line arrow marks of FIG. 11.

The 2 sets of the slit-like photodiodes 61, 62 photoelectrically convert light into analog signals in a shape of a sine wave, and the respective photodiodes are further constituted by 2 sets of slit-like photodiodes 61a, 61b, 62a, 62b for electrically detecting signals having phase differences of 180 degrees.

There is constituted a so-to-speak differential detecting system of photoelectrically converting light by 2 sets of the slit-like photodiodes 61, 62 and providing the electric signals in the shape of sine wave by a differential circuit of the electronic part 7.

There is constructed a constitution in which the sine wave signals of the slit-like photodiodes 61, 62 provided in this way become electric signals having the phase difference of 90 degrees there between and transmitted to outside

### (Waveform Signal is Not Illustrated)

Further, as an example of a technology of fabricating a resin molded board capable of providing three-dimensional wirings, an article having a plated conductive path on a nonconductive substance is known (refer to, for example, Patent Reference 2). According thereto, there is provided a fabricating method for providing a fine conductive metal plated film on a surface of the resin molded product.

### Patent Reference 1: JP-M-A-1-180615

### Patent Reference 2: JP-A-7-326414

### DISCLOSURE OF THE INVENTION

### Problems that the Invention is to Solve

However, the reflection type optical detector using three lattices of the background art poses the following problem.

(1) According to the detecting unit 2, the light emitting portion and the light receiving portion are integrated by using parts of LED 51, the sub-board 4, the spacer 54, the lead 56, the light emitting portion slit 7 for the LED light source, the slit-like photodiodes 61, 62, the bonding wire 9 and the like, and therefore, a number of parts is large, the constitution is complicated and the detecting unit 2 cannot be downsized.

### (2) Since the constitution is complicated, an error is brought about in integrating the respective parts, and high accuracy integration cannot be carried out.

(3) Particularly, in positioning the photodiodes, phases of signals outputted from the respective photodiodes need to be adjusted, much adjusting time period is taken for fixing the photodiodes in a predetermined positional relationship to thereby cause a factor of an increase in cost in integration.

In this way, the reflection type optical detector of the background art poses a problem in which time is taken in integrating the detecting unit or time is taken in adjustment for constituting the accuracy.

The invention has been carried out in view of such a problem and it is an object thereof to provide a reflection type optical detector capable of simplifying structures of a light emitting portion and a light receiving portion in a detecting unit, preventing an outer shape dimension from being enlarged, and capable of highly accurately and simply integrating a photodiode and respective slits.

### Means for Solving the Problems

In order to resolve the above-described problem, the invention is constituted as follows.

According to claim 1, there is provided a reflection type optical detector including:

a relatively moving main slit,

a detecting unit opposed thereto, the detecting unit including a light emitting portion, a light emitting portion slit and a light receiving portion, wherein

the detecting unit includes a resin molded board capable of carrying out three-dimensional wirings,

a light emitting element of the light emitting portion is directly arranged at a portion of the resin molded board,

a periphery of the light emitting element is provided with a reflecting portion in a shape of a fulcrum of circular cone, and

the reflecting portion is formed by a metal wiring pattern for electrically connecting the light emitting element.

According to claim 2, the metal wiring pattern is constituted by a pattern for radiating heat for radiating the heat of the light emitting element to outside by transferring the heat.

According to claim 3, the light emitting portion slit is constituted by one piece of a composite slit adding to integrate a slit arranged at the light receiving portion by using a transparent molding resin.

According to claim 4, the resin molded board includes a reference portion for positioning to fix at least one of the light emitting portion slit, the light receiving element of the light receiving portion and the composite slit.

According to claim 5, a height of the resin molded board is adjusted to a predetermined height such that a face of the light emitting portion slit and a face of the light receiving element or a face of the composite slit constitute the same plane.

According to claim 6, the resin molded board is provided with pressing means for positioning to fix the composite slit or the light receiving element by a predetermined pressure.

According to claim 7, a portion of the resin molded board is provided with a positioning reference portion for positioning to fix the board.

### EFFECTS OF THE INVENTION

According to the invention, the following effect is achieved.

(1) According to the invention according to claim 1, the light emitting portion and the light receiving portion are constituted by the resin molded board capable of carrying out three-dimensional wirings, LED of the light emitting portion is directly arranged at a portion of the resin molded board, the periphery of the LED is provided with the reflecting portion in the shape of the fulcrum of circular cone, the reflecting portion is formed by the metal wiring pattern for electrically connecting LED, and therefore, a light emitting efficiency of LED can be promoted
(2) According to the invention according to claim 2, by radiating heat generated at LED by transferring the heat to outside by way of the wiring pattern, a temperature of LED can be lowered, and therefore, service life of LED can be prolonged, and reliability of the reflection type optical detector is promoted.
(3) According to the invention according to claim 3, the composite slit is constituted by integrating the light emitting portion slit and the slit of the light receiving portion by using the transparent molding resin, and therefore, the detecting unit is simplified, an outer shape dimension is not increased, further, the light emitting portion slit and the light receiving portion slit can highly accurately and simply be integrated.
(4) According to the invention according to claim 4, the resin molded board is provided with the reference portion for positioning to fix, and therefore, the light emitting portion slit, the light receiving element of the light receiving portion and the composite slit can highly accurately be positioned, and a phase needs not be adjusted.
(5) According to the invention according to claim 5, the height of the resin molded board is adjusted to the predetermined height such that the face of the light emitting portion slit and the face of the light receiving element or the face of the composite slit constitute the same plane, and therefore, an integrating accuracy can be promoted.
(6) According to the invention according to claim 6, the resin molded board is provided with the pressing means for positioning to fix the composite slit or the light receiving element by the predetermined pressure, and therefore, when fixed while being pressed to the positioning reference portion, both slits of the light emitting portion and the light receiving portion can highly accurately be positioned, further, the light receiving element can highly accurately be positioned.
(7) According to the invention according to claim 7, a portion of the resin molded board is provided with the positioning reference portion for positioning to fix the board, and therefore, the board can be integrated simply and can accurately be attached.

### BRIEF DESCRIPTION OF THE DRAWINGS

FIG. 1 is a side sectional view of a reflection type optical detector showing a first embodiment of the invention.

FIG. 2 is a perspective view of a detecting unit of FIG. 1.

FIG. 3 is a perspective view of a resin molded board showing the first embodiment of the invention.

FIG. 4 is an enlarged sectional view viewed from a line a-a′ of FIG. 3.

FIG. 5 is a perspective view of a resin molded board showing a second embodiment of the invention.

FIG. 6 is a side sectional view of a reflection type optical detector showing a third embodiment of the invention.

FIG. 7 is a perspective view of a resin molded board showing the third embodiment of the invention.

FIG. 8 is a perspective view of a composite slit showing the third embodiment of the invention.

FIG. 9 is a sectional view of a composite slit showing a fourth embodiment of the invention.

FIG. 10 is an enlarged sectional view of a composite slit showing a fifth embodiment of the invention.

FIG. 11 is a side sectional view showing a total constitution of a reflection type optical detector of a background art.

FIG. 12 is a perspective view showing a detecting unit of the reflection type optical detector of the background art.

### DESCRIPTION OF REFERENCE NUMERALS AND SIGNS

1 . . . main scale
2 . . . detecting unit
3 . . . board
4 . . . sub-board
41 . . . resin molded board
42 . . . metal wiring pattern
43 . . . electrode
44 . . . pad
45 . . . positioning pillar
46 . . . positioning hole
5 . . . light emitting portion
51 . . . LED
52 . . . LED case
53 . . . glass
54 . . . spacer
55 . . . LED terminal
56 . . . lead
57 . . . reflecting portion
6 . . . light receiving portion
61, 61a, 61b, 62, 62a, 62b . . . slit-like photodiodes
63, 63a, 63b, 64, 64a, 64b . . . photodiodes
65 . . . photodiode electrode
7 . . . light emitting portion slit
8 . . . composite slit
8a . . . composite slit (light emitting portion side)
8b . . . composite slit (light receiving portion side)
9 . . . bonding wire
10 . . . electronic part
A, B, D . . . positioning reference portions
C, F . . . spring function portions
E . . . gap

### BEST MODE FOR CARRYING OUT THE INVENTION

Embodiments of a reflection type optical detector will be explained in details in reference to the drawings as follows.

### EMBODIMENT 1

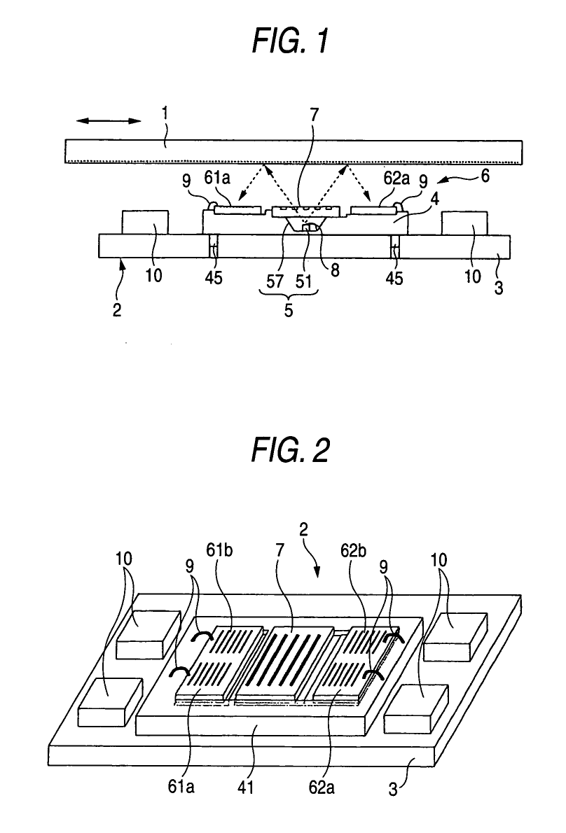

A sectional of a reflection type optical detector according to a first embodiment of the invention is shown in FIG. 1, a perspective view of a detecting unit of FIG. 1 is shown in FIG. 2. In the drawings, numeral 41 designates the resin molded board formed by molding a resin, numeral 45 designates the positioning pillar. Other notations are the same as those of the background art, and therefore, an explanation thereof will be omitted. Further, according to the invention, an explanation will be given by unifying a technical term as ‘resin molded board’ capable of carrying out three-dimensional wirings.

A point of the invention which differs from the background art resides in using the resin molded board 41 capable of carrying out three-dimensional wirings by abolishing the sub-board 4 used in the detecting unit 2. Thereby, constituent parts of the light emitting portion and the light receiving portion can be reduced and dimensional accuracies of respective portions can be promoted by resin molding.

The resin molded board 41 is molded by a die, and therefore, the resin molded board 41 can be fabricated by a dimensional accuracy of the die, and the highly accurate resin molded board 41 having dimensional errors of respective portions of about 5 through 10 micrometers can be provided.

Therefore, in a case in which when the light emitting portion slit 7 of LED 51 and the slit-like photodiodes 61, 62 of the light receiving portion 6 are fixed, these are integrated by constituting a positioning reference by a portion of the resin molded board 41, high accuracy integration can be carried out.

Further, also LED 51 is directly attached to a portion of the resin molded board 41, and therefore, LED 51 can be integrated with high accuracy in a positional relationship with the light emitting portion slit 7 or the slit-like photodiodes 61, 62.

According to a method of fabricating the light emitting portion slit 7, the light emitting portion slit 7 is fabricated on glass constituting the board by freely using a photographic exposing technology, an etching technology or the like similar to those in a semiconductor fabricating method. Further, according to an outer shape of glass formed with the slits, a dimension thereof is ensured by cutting an outer shape dimension by using a dicing saw for cutting a silicon wafer of a semiconductor, and therefore, the outer shape can highly accurately be fabricated by a dimensional error of about 5 micrometers also in a positional relationship between a position of the formed slit and the outer shape dimension.

Similarly, also the photodiode is fabricated by freely using the same semiconductor technology, and therefore, the photodiode can be highly accurately fabricated by a dimensional error of about 5 micrometers in a positional relationship between a position of the photodiode in the slit-like shape and the outer shape dimension.

From the above-described, according to accuracies of integrating respective parts, dimensional errors thereof are constituted by unit of a micrometer, and the respective parts can highly accurately be integrated.

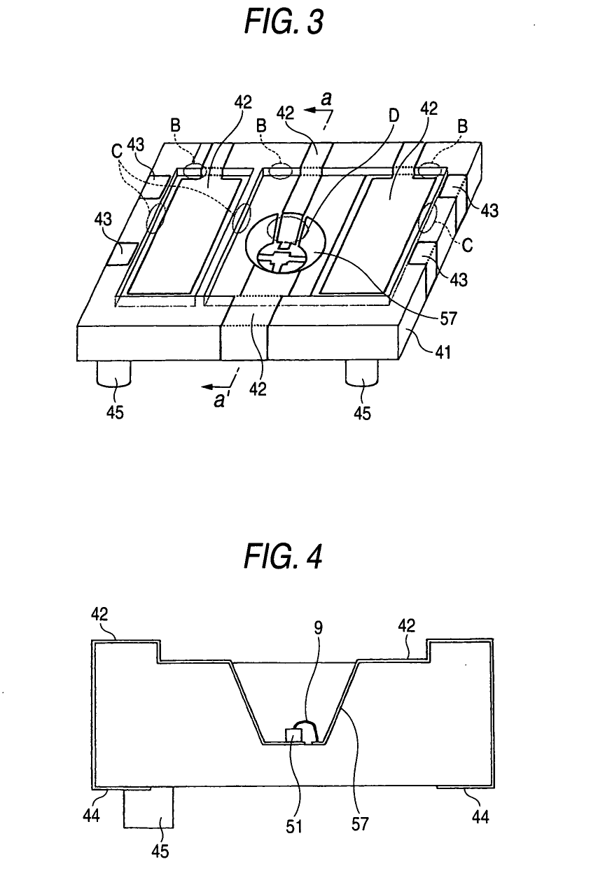

The light emitting portion 5 and the light receiving portion 6 are constituted by the resin molded board 41 capable of carrying out three-dimensional wirings, LED 51 of the light emitting portion 5 is directly arranged at a portion of the resin molded board 41, and the reflecting portion 57 in the shape of the fulcrum of circular cone is provided at a periphery of LED 51. The reflecting portion 57 is formed by the metal wiring pattern 42 (refer to FIG. 3) for electrically connecting LED 51. According to LED 51 and the metal wiring pattern 42, a bottom face of LED 51 is fixed by conductive adhering agent, and an upper portion of LED 51 is connected to other of the metal wiring pattern 42 by the bonding wire 9 (refer to FIG. 4).

FIG. 3 is a perspective view showing details of the resin molded board 41, FIG. 4 is a sectional view taken along a line a-a′ of FIG. 3. In the drawings, numeral 42 designates the metal wiring pattern, numeral 43 designates the electrode, numeral 44 designates the pad.

Although copper is normally used for the metal wiring pattern 42, in order to prevent a copper surface from being oxidized, copper is prevented from being oxidized by subjecting copper to gold plating, by gold plating. There is achieved an effect of preventing copper from being oxidized and capable of promoting a light emitting efficiency of LED 51 without reducing reflectance of the reflecting portion.

Since two pieces of the metal wiring patterns 42 for connecting the electrodes (anode, cathode) of LED 51 are contiguous to the reflecting portion 57, the reflecting portion 57 is patterned to be spaced apart therefrom by a minimum insulating interval as in portion D indicated by a dotted line ellipse to thereby prevent a reflecting efficiency from being reduced by a gap of an insulating portion.

Although LED 51 of the light emitting portion 5 is wired by the metal wiring pattern 42, in order to escape heat generated at LED 51, a width of the metal wiring pattern 42 is made to be bold to thereby radiate heat by transferring heat to outside. Service life of LED 51 is shortened when a temperature thereof is elevated, and therefore, by lowering the temperature of LED 51 by radiating heat, the service life is prolonged, which as a result, amounts to promote reliability of the reflection type optical detector.

Next, a method of fixing the light emitting portion slit 7 and the slit-like photodiodes 61, 62 will be explained in reference to FIG. 3.

The light emitting portion slit 7 and the photodiode can highly accurately be positioned to fix when two sides of outer shapes of the light emitting portion slit 7 and the slit-like photodiodes 61, 62 including right angle corners thereof are fixed while being pressed respectively to B, C portions by constituting references by three portions of B, C portions of the resin molded board 41 indicated by dotted line ellipses as described above.

Further, a common electrode (cathode or anode) and the metal wiring pattern 42 at a back face of the photodiode are fixed by using a conductive adhering agent and connected to the board 3 from the metal electrode pattern by way of the electrode 44 of the resin molded board 41.

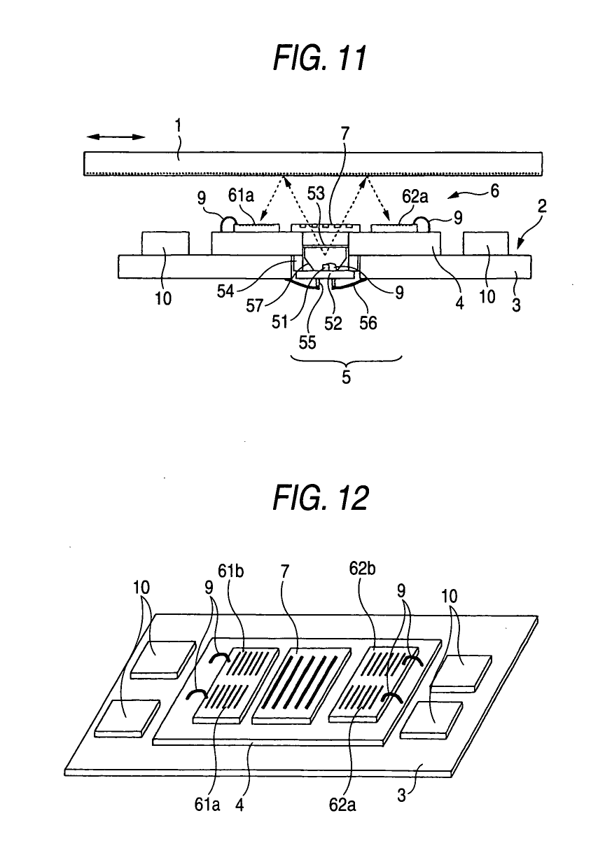

Further, as shown by FIG. 1, by adhering to fix the light emitting portion slit 7, the light emitting portion slit 7 protects LED 51, and therefore, the glass 53 shown in the background art of FIG. 11 is dispensed with.

As is known from FIG. 1, height dimensions (thicknesses) of the light emitting portion slit 7 and the slit-like photodiodes 61, 62 differ from each other, and therefore, faces thereof opposed to the main scale 1 need to be constituted by the same plane. Therefore, the sate height dimension can be ensured by constituting heights of the resin molded board 41 at locations of fixing the light emitting portion slit 7 and the slit-like photodiodes 61, 62 by predetermined heights. This is also characterized by enabling to fabricate the resin molded board 41 by resin molding.

The light emitting portion and the light receiving portion are finished to integrate when electrodes (not illustrated) of the slit-like photodiodes 61, 62 and the electrodes 43 of the resin molded board 41 by the bonding wires 9, after fixing the light emitting portion slit 7 and the slit-like photodiodes 61, 62.

The positioning pillar 45 constitutes a reference when the resin molded board 41 and the board 3 are positioned to fix to accurately integrate. The positioning pillars 45 at two portions are fabricated by resin molding and therefore, the positioning pillars 45 are fabricated by an accuracy of about 5 micrometers in a dimension of the circular pillar and an error of an interval between the pillars at the two portions. Two portions of holes are prepared at the board 3, and the positioning pillars 45 are inserted thereinto to be positioned to fix.

The pads 44 are connected to a wiring pattern (not illustrated) arranged at the board 3 by soldering.

By integrating as described above, light emitted by LED 51 can be received by the slit-like photodiodes 61, 62 by passing routes indicated by dotted line arrow marks of FIG. 1.

### EMBODIMENT 2

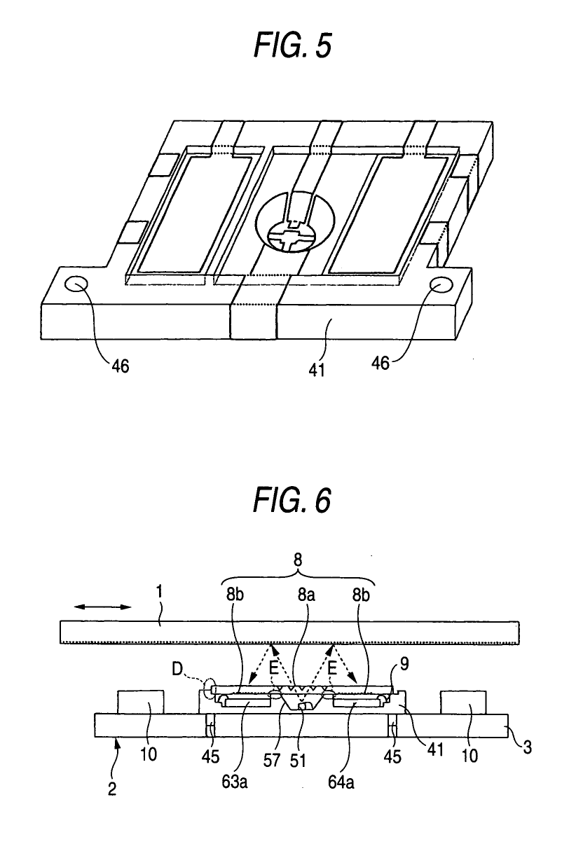

FIG. 5 is a perspective view of the resin molded board 41 showing a second embodiment of the invention. In the drawing, numeral 46 designates the positioning hole. According to the embodiment, the positioning pillar 45 is changed to the positioning hole 46.

The positioning holes 46 are provided at two portions and are constituted to be fixed to the board 3 by 2 pieces of pins or screws.

In this case, there is not a projected portion as in the positioning pillar 45, and therefore, there is not a drawback of breaking the positioning pillar 45 in integration.

### EMBODIMENT 3

FIG. 6 shows a constitution of a reflection type optical detector according to a third embodiment of the invention. In the drawing, numerals 63, 64 designate the photodiodes, numeral 8 designates the composite slit, notation 8a designates the composite slit (light emitting portion side), notation 8b designates the composite slit (light receiving portion side).

The composite slit 8 according to the embodiment integrates the light emitting portion and the light receiving portion by extending the light emitting portion slit 7 of FIG. 1 to the light receiving portion. Thereby, it is characterized that a number of parts is reduced and dimensions of respective portions are highly accurately be molded.

According to a slit fabricating method of the composite slit 8, the slit is constituted by a shape of a V groove by a base member of the transparent resin. The method of forming the slit in the shape of the V groove is disclosed in JP-A-9-89593 and is a publicly-known technology. The resin is molded by a die capable of ensuring high accuracy similar to that of the resin molded board 41, and therefore, the slit can be fabricated by a dimensional error of about 5 micrometers in a position of the resin formed composite slit 8 and a positional relationship thereof with an outer shape dimension.

Similarly, also the photodiodes 63, 64 constituting the light receiving elements are fabricated by freely using the semiconductor technology, and therefore, the photodiodes can highly accurately be fabricated by a dimensional error of about 5 micrometers in positions of the photodiodes 63, 64 and a positional relationship thereof with the outer shape dimension.

From the above-described, accuracies of integrating respective parts are constituted by dimensional errors of a unit of a micrometer, and the respective parts can highly accurately be integrated.

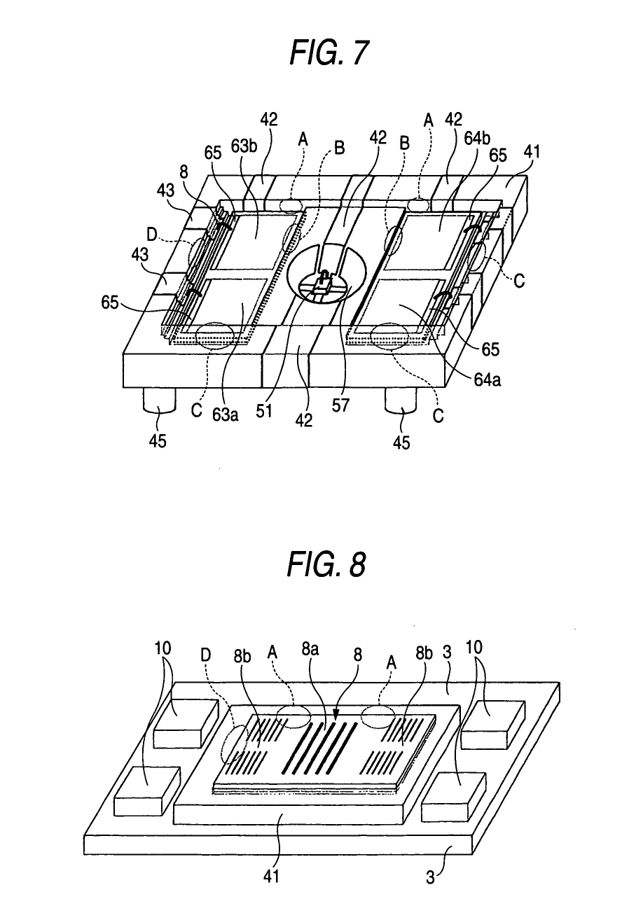

Further, LED 51 of the light emitting portion 5 is directly arranged at a portion of the resin molded board 41, and the reflecting portion 57 in a shape of a fulcrum of circular cone is provided at a periphery of LED 51. The reflecting portion 57 is formed by the metal wiring pattern 42 (refer to FIG. 7) for electrically connecting LED 51. According to LED 51 and the metal wiring pattern 42, the bottom face of LED 51 is fixed by a conductive adhering agent, the upper portion of LED 51 is connected to the other metal wiring pattern 42 by the bonding wire 9.

The gap E between the composite slit 8 and a front end portion of the reflecting portion 57 is narrowed. This is for blocking light such that light from LED is not directly incident on the photodiode.

The positioning pillar 45 constitutes the reference when the resin molded board 41 and the board 3 are positioned to fix to accurately integrate. The positioning pillars 45 at two portions are fabricated by resin molding, and therefore, the positioning pillars 45 are fabricated by an accuracy of about 5 micrometers in the dimension of the circular pillar and the error in the interval there between. Two portions of holes are prepared for the board 3, the positioning pillars 45 are inserted thereinto to be positioned to fix.

FIG. 7 is a perspective view showing details of a state of integrating LED 51, mounting the photodiodes 63, 64 to the resin molded board 41 to be fixed at predetermined positions and connecting the bonding wires 9.

Gold plated copper is used for the metal wiring pattern 42. Although copper is normally used for the metal wiring pattern 42, in order to prevent the copper surface from being oxidized, copper is prevented from being oxidized by subjecting copper to gold plating. It is characterized that copper is prevented from being oxidized by gold plating, the reflectance of the reflecting portion is not reduced, and the light emitting efficiency of LED 51 can be promoted.

Since the reflecting portion 57 is contiguous to two pieces of metal wiring patterns 42 for connecting the electrodes (anode, cathode) of LED 51, the reflecting portion 57 is patterned by being spaced apart therefrom by the minimum insulating interval to thereby prevent the reflecting efficiency from being reduced by the gap of the insulating portion. Although LED 51 of the light emitting portion is wired by the metal wiring pattern 42, in order to escape heat generated by LED 51, the width of the metal wiring pattern 42 is made to be bold to radiate heat by transferring heat to outside. The service life of LED 51 is shortened when the temperature is elevated, and therefore, the service life is prolonged by lowering the temperature of LED 51 by radiating heat, which as a result, amounts to promote reliability of the reflection type optical detector.

Next, the method of fixing the photodiodes 63, 64 will be explained.

The photodiodes 63, 64 can highly accurately be positioned to fix the resin molded board 41 when the photodiodes 63, 64 are fixed thereto while being respectively pressed to A, B portions of two sides of outer shapes of the photodiodes 63, 64 including right angle corners thereof by constituting positioning reference portions by two portions of A, B portions in correspondence with the respective photodiodes 63, 64 indicated by dotted line ellipses of the resin molded board 41.

Further, a common electrode (cathode or anode) of the back face of the photodiode and the metal wiring pattern 42 are fixed by using a conductive adhering agent.

The photodiodes 63, 64 are finished to integrate when the photodiode electrodes 65 and the electrodes 43 of the resin molded board 41 are connected by the bonding wires 9 after fixing the photodiodes 63, 64.

A method of integrating the composite slit 8 will be explained in reference to FIG. 8. FIG. 8 is a perspective view of the detecting unit.

The composite slit 8 can highly accurately be fixed to the resin molded board 41 when the composite slit 8 is fixed by an adhering agent while pressing the composite slit 8 to positioning reference portions A (two portions, the positioning reference portions of the photodiodes are used also therefor), D (one portion) provided at the resin molded board 41 after integrating the photodiodes.

### EMBODIMENT 4

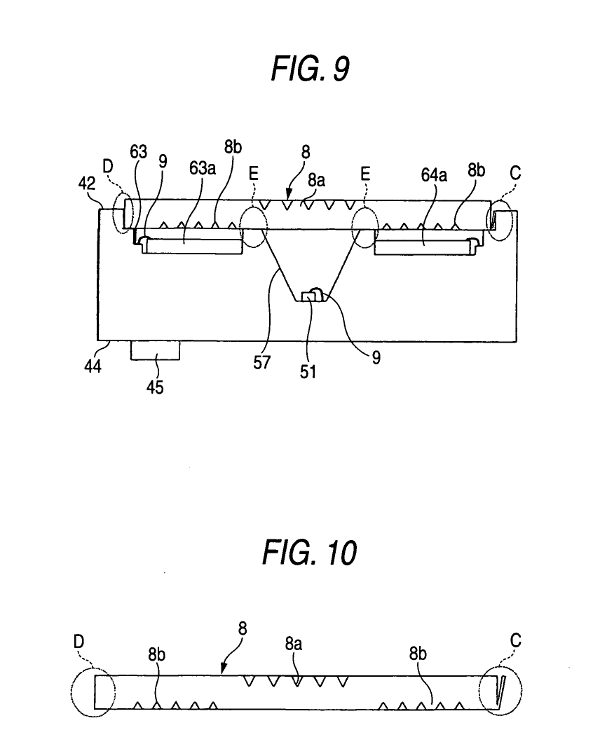

FIG. 9 is a sectional view for explaining a method of fixing the composite slit 8 according to a fourth embodiment of the invention. A portion of the resin molded board 41 is provided with the spring function portion C (refer to 3 portions of C portions, FIG. 7) for fixing the light emitting/receiving slit 41 by a predetermined pressure. Therefore, when the composite slit 8 is inserted into the resin molded board 41 to be fixed thereby, the spring function portion C is worked, the composite slit 8 is pressed to the positioning reference portions A, D of the resin molded board 41 by the predetermined pressure to be able to be highly accurately positioned.

Further, output signals of the photodiodes 63, 64 are connected to a wiring pattern (not illustrated) arranged at the board 3 by the pad 44 by way of the bonding wire 9, the photodiode electrode 65, the metal wiring pattern 42 by soldering.

### EMBODIMENT 5

FIG. 10 is an enlarged sectional view for explaining a method of fixing the composite slit 8 according to a fifth embodiment of the invention. This is an embodiment arranged with the spring function portion C arranged at the resin molded board 41 mentioned above at the composite slit B.

The composite slit 8 molded by the transparent integrally molding resin is arranged with the spring function portion F for being fixed by a predetermined pressure. By adopting such a structure, when the composite slit 8 is inserted into the resin molded board 41 to be fixed thereby, the spring function is worked, and the composite slit 8 is pressed to the position reference portion D of the resin molded board 41 by the predetermined pressure to be able to be highly accurately positioned. Further, the spring function portion F pressed to the positioning reference portion A is not illustrated since the spring function portion F is the same as the spring function portion C.

Although an explanation has been given of the invention in details and in reference to the specific embodiments, it is apparent for the skilled person that the invention can be changed or modified variously without deviating from the spirit and the range of the invention.

The application is based on Japanese Patent Application No. 2004-213939 filed on Jul. 22, 2004 and a content thereof is incorporated herein by reference.

### INDUSTRIAL APPLICABILITY

The intention is applicable not only to the reflection type optical detector of the linear type but also to a reflection type optical detector of a rotational type for detecting an angle.

Further, the invention is applicable not only to the reflection type optical detector of three lattices explained in the embodiments but also to the reflection type optical detector of the background art using the main scale and the photodiode in the lattice shape so far as the detecting unit is the detecting unit constituted by the resin molded board capable of carrying out three-dimensional wirings at the light emitting portion and the light receiving portion.

Further, the invention is not limited only to the embodiments but is applicable also to a detecting unit so far as the detecting unit is a detecting unit using the transparent resin at the slit integrated with the light emitting portion slit and the light receiving portion slit.

1. A reflection type optical detector comprising: a relatively moving main slit, and
a detecting unit opposed thereto, the detecting unit including at least a light emitting portion, a light emitting portion slit and a light receiving portion, wherein
the detecting unit includes a resin molded board capable of carrying out three-dimensional wirings,
a light emitting element of the light emitting portion is directly arranged at a portion of the resin molded board,
a periphery of the light emitting element is provided with a reflecting portion in a shape of a fulcrum of circular cone, and
the reflecting portion is formed by a metal wiring pattern for electrically connecting the light emitting element.

2. The reflection type optical detector according to claim 1, wherein
the metal wiring pattern is constituted by a pattern for radiating heat for radiating the heat of the light emitting element to outside by transferring the heat.

3. The reflection type optical detector according to claim 1, wherein
the light emitting portion slit is constituted by one piece of a composite slit adding to integrate a slit arranged at the light receiving portion by using a transparent molding resin.

4. The reflection type optical detector according to claim 1, wherein
the resin molded board includes a reference portion for positioning to fix at least one of the light emitting portion slit, the light receiving element of the light receiving portion and the composite slit.

5. The reflection type optical detector according to claim 1, wherein
a height of the resin molded board is adjusted to a predetermined height such that a face of the light emitting portion slit and a face of the light receiving element or a face of the composite slit constitute the same plane.

6. The reflection type optical detector according to claim 1, wherein
the resin molded board is provided with pressing means for positioning to fix the composite slit or the light receiving element by a predetermined pressure.

7. The reflection type optical detector according to claim 1, wherein
a portion of the resin molded board is provided with a positioning reference portion for positioning to fix the board.
